(19) United States
(12) Patent Application Publication
(10) Pub. No.: US 2024/0320677 A1
(43) Pub. Date: Sep. 26, 2024

(54) SYSTEM AND METHOD TO INVESTIGATE THREAT ACTORS IN CRYPTOCURRENCY TRANSACTIONS

(71) Applicant: CYBLE INC., Alpharetta, GA (US)

(72) Inventors: Beenu Arora, CRAIGIEBURN (AU); Amit Pundalikarao Lokhande, Haveri (IN)

(21) Appl. No.: 18/189,271

(22) Filed: Mar. 24, 2023

(51) Int. Cl. G06Q 20/40; G06Q 20/36; G06Q 20/38

(52) U.S. Cl. CPC G06Q 20/4016; G06Q 20/363; G06Q 20/389; G06Q 20/4014

(57) ABSTRACT

A system and method to investigate threat actors in cryptocurrency transactions is provided. The system includes a receiving module to acquire a plurality of blockchain transactions, personally identifiable information from a plurality of data sources and data of one or more known threat actors with corresponding wallet addresses. The system includes a correlation engine to map the blockchain transactions with the personally identifiable information. Further, the system includes a vision module to display one or more graphical representations depicting the plurality of blockchain transactions and the one or more known threat actors with the corresponding walled addresses. Furthermore, the system includes a record module to deliver a plurality of user stories and check for a change in at least one of the personally identifiable information and blockchain transactions thereby identifying a potential threat actor.

### FIELD OF INVENTION

Embodiments of the present disclosure relate to the field of cryptocurrency, and, more particularly, a system and a method to investigate threat actors or Person Of Interest (POI) in cryptocurrency transactions.

### BACKGROUND

Cryptocurrencies, such as bitcoin, are increasingly being used as a method of purchasing goods and services. For example, bitcoin and similar currencies are being accepted by vendors and providers of online goods and services. Recently, users who want to purchase cryptocurrency have signed up on cryptocurrency exchanges, opened an electronic wallet and transferred their investment amount. Further, a transaction of transfer cryptocurrency between two parties may utilize a cryptocurrency network of computers that jointly manage an electronic ledger of transactions.

The rise and proliferation of cryptocurrency has also provided attackers with a new way of financial extraction. Cryptocurrency provides an appealing financial resource for threat actors. There have been multiple cases of scams and cyber attacks by Threat Actors, leveraging cryptocurrency as a payout method.

Hence, there is a need for an improved system and method for investigating threat actors or Person Of Interest (POI) in cryptocurrency transactions which addresses the aforementioned issue(s).

### BRIEF DESCRIPTION

In accordance with an embodiment of the present disclosure, a system to investigate threat actors in cryptocurrency transactions is provided. The system includes a processing subsystem hosted on a server. The processing subsystem is configured to execute on a network to control bidirectional communications among a plurality of modules. The processing subsystem includes a receiving module configured to acquire a plurality of blockchain transactions, personally identifiable information from a plurality of data sources and data of one or more known threat actors with corresponding wallet addresses. The processing subsystem also includes a correlation engine operatively coupled to the receiving module wherein the correlation engine is configured to map the blockchain transactions with the personally identifiable information. Further, the processing subsystem includes a vision module operatively coupled to the correlation engine wherein the vision module is configured to display one or more graphical representations depicting the plurality of blockchain transactions and the one or more known threat actors with the corresponding wallet addresses. Furthermore, the processing subsystem includes a record module operatively coupled to the vision module wherein the record module is configured to deliver a plurality of user stories and check for a change in at least one of the personally identifiable information and blockchain transactions thereby identifying a potential threat actor.

In accordance with an embodiment of the present disclosure, a computer-implemented method to investigate threat actors in cryptocurrency transactions is provided. The computer-implemented method includes, the acquiring, by a receiving module of a processing subsystem, a plurality of blockchain transactions, personally identifiable information from a plurality of data sources and data of one or more known threat actors with corresponding wallet addresses. The computer-implemented method includes mapping, by a correlation engine of the processing subsystem, the blockchain transactions with the personally identifiable information. Further, the computer-implemented method includes displaying, by a vision module of the processing subsystem, one or more graphical representations depicting the plurality of blockchain transactions and the one or more known threat actors with the corresponding wallet addresses. Furthermore, the computer-implemented method includes expanding, by the vision module of the processing subsystem, the one or more graphical representations on the wallet addresses thereby allowing the user to view additional information for the said wallet addresses. Moreover, the computer-implemented method includes delivering, by a record module of the processing subsystem, a plurality of user stories. The computer-implemented method includes checking, by the record module of the processing subsystem, a change in at least one of the personally identifiable information and blockchain transactions thereby identifying a potential threat actor.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to investigate threat actors or Person Of Interest (POI) in accordance with an embodiment of the present disclosure;

FIG. 2 is a schematic representation of an exemplary embodiment of a system to investigate threat actors of FIG. 1 in accordance with an embodiment of the present disclosure;

FIG. 3 is a block diagram of a computer or a server in accordance with an embodiment of the present disclosure;

FIG. 4a, FIG. 4b and FIG. 4c are schematic representations of use case scenarios of a system to investigate threat actors of FIG. 1 in accordance with an embodiment of the present disclosure;

FIG. 5 illustrates a flow chart representing the steps involved in a method for investigating threat actors in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

In accordance with an embodiment of the present disclosure, a system to investigate threat actors in cryptocurrency transactions is provided. The system includes a processing subsystem hosted on a server. The processing subsystem is configured to execute on a network to control bidirectional communications among a plurality of modules. The processing subsystem includes a receiving module configured to acquire a plurality of blockchain transactions, personally identifiable information from a plurality of data sources and data of one or more known threat actors with corresponding wallet addresses. The processing subsystem also includes a correlation engine operatively coupled to the receiving module wherein the correlation engine is configured to map the blockchain transactions with the personally identifiable information. Further, the processing subsystem includes a vision module operatively coupled to the correlation engine wherein the vision module is configured to display one or more graphical representations depicting the plurality of blockchain transactions and the one or more known threat actors with the corresponding walled addresses. Furthermore, the processing subsystem includes a record module operatively coupled to the vision module wherein the record module is configured to deliver a plurality of user stories and check for a change in at least one of the personally identifiable information and blockchain transactions thereby identifying a potential threat actor.

The system and method disclosed herein aims at tracking threat actors in cryptocurrency transactions. Personally Identifiable Information (PII) and crypto currency transactions are gathered and investigated to identify the threat actors or trails of information to identify any individuals that are required to be investigated.

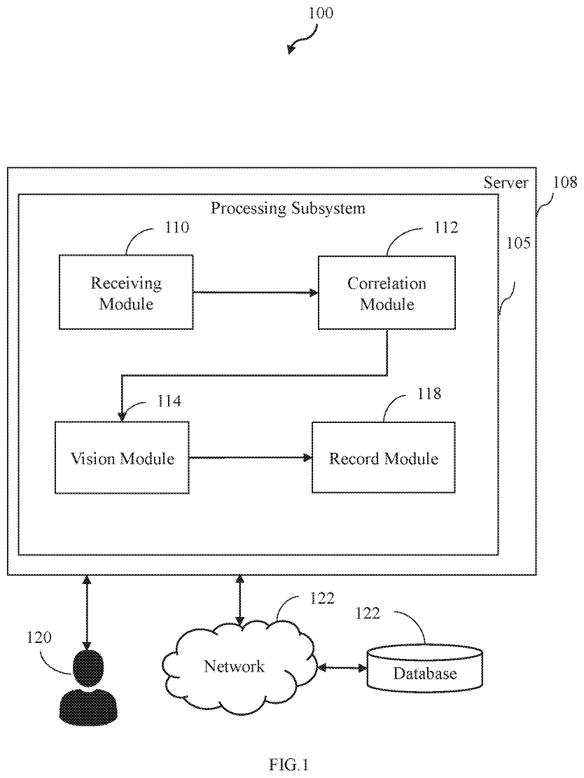

FIG. 1 is a block diagram representation of a system 100 to investigate threat actors or Person Of Interest (POI) in accordance with an embodiment of the present disclosure. The system 100 includes a processing subsystem 105 hosted on a server 108. In one embodiment, the server 108 may include a cloud-based server. In another embodiment, parts of the server 108 may be a local server. The processing subsystem 105 is configured to execute on a network 122 to control bidirectional communications among a plurality of modules. In one example, the network 122 may be a private or public local area network (LAN) or Wide Area Network (WAN), such as the Internet. In another embodiment, the network 122 may include both wired and wireless communications according to one or more standards and/or via one or more transport mediums. In one example, the network 122 may include wireless communications according to one of the 802.11 or Bluetooth specification sets, or another standard or proprietary wireless communication protocol. In yet another embodiment, the network 122 may also include communications over a terrestrial cellular network, including, a global system for mobile communications (GSM), code division multiple access (CDMA), and/or enhanced data for global evolution (EDGE) network.

The processing subsystem 105 includes a receiving module 110 configured to acquire a plurality of blockchain transactions, personally identifiable information from a plurality of data sources and data of one or more known threat actors with corresponding wallet addresses.

In one embodiment, the personally identifiable information is collected from a plurality of data points corresponding to a plurality of data sources. Examples of the data sources includes, but is not limited to, cryptocurrency transactions, data breaches, stealer logs and ransomware attacks. The cryptocurrency transactions refer to data points such as wallet addresses of the Person of Interest (POI), wallet addresses of other possible POIs who have made transactions. The data breaches refers to third-party data breaches and is specifically related to data that is shared on dark web from people who have suffered breaches. Examples of the breaches include, but is not limited to, name, email id, mobile number, house address, IP addresses, national identification numbers and passport numbers. Further, stealer logs are malware that captures data points such as user name, password (in plaintext), URL, system information and IP address. These data points are then shared in dark web. Furthermore, the ransomware attacks obtain data from organizations and are stored in ransomware group's websites and cybercrime forums. The data is typically valuable personally identifiable information and trade secrets of the organizations.

It must be noted that the above mentioned data sources are used to investigate potential threat actors in cryptocurrency. Specifically, the said data sources provide details of transactions and PII that narrows down the search for threat actors and also identifies sensitive material or identity that can be exploited. Further, the details of the transactions are correlated with information obtained from the data sources with KYC details to identify threat actors and trace their past digital footprint via third-party data breaches.

In one embodiment, the personally identifiable information from the third party breaches is in the form of a structured file with uniform headers wherein the uniform headers are added at the occurrence of new data.

Further, the processing subsystem 105 includes a correlation module 112 engine operatively coupled to the receiving module wherein the correlation engine is configured to map the blockchain transactions with the personally identifiable information.

In one embodiment, the blockchain transactions are received from a blockchair application programming interface wherein the blockchair application programming interface provides periodic data and historical data of the plurality of transactions in a structured format. In such an embodiment, the blockchair application programming interface is configured to compare a block address corresponding to a latest transaction with a block address corresponding to a latest read transaction from the blockchain thereby obtaining a list of block addresses to investigate in the blockchain. The blockchair application programming interface is also configured to obtain details of a list of transactions corresponding to one or more pending block addresses.

In one embodiment, the blockchair application programming interface provides current statistics for cryptocurrencies.

Furthermore, the processing subsystem 105 includes a vision module 114 operatively coupled to the correlation engine wherein the vision module is configured to display one or more graphical representations depicting the plurality of blockchain transactions and the one or more known threat actors with the corresponding wallet addresses.

It must be noted that the one or more graphical representations display the details of plurality of blockchain transactions in in a text format.

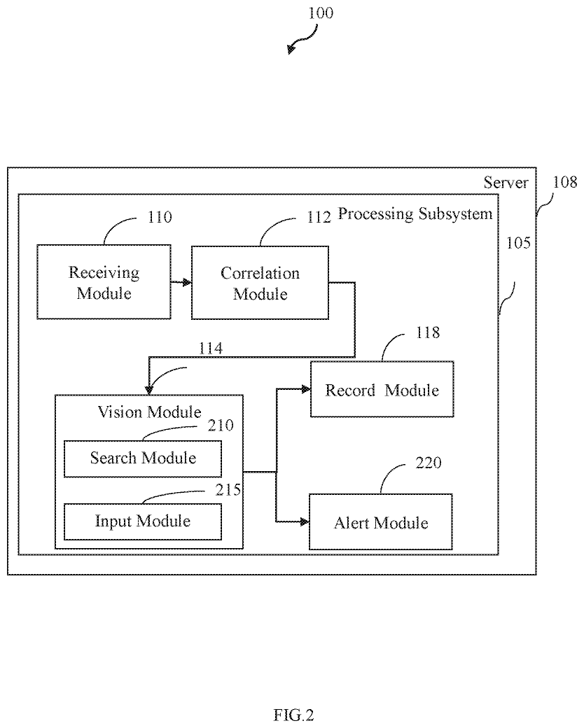

In one embodiment, the vision module 114 is configured to expand the one or more graphical representations on the wallet addresses thereby allowing the user 120 to view additional information for the said wallet addresses. The vision module 114 is further explained in detail in FIG. 2.

Moreover, the processing subsystem 105 includes a record module 118 operatively coupled to the vision module wherein the record module is configured to deliver a plurality of user stories and check for a change in at least one of the personally identifiable information and blockchain transactions thereby identifying a potential threat actor.

In one embodiment, one or more unspent transactions are identified and are periodically monitored to examine an occurrence of expenditure.

Additionally, the system 100 includes a database 122 to store PII and details of the blockchain transactions. The database 122 may be stored in persistent storage such as a disk for durability, it may be stored in high-speed memory for performance, or it may use a combination of these storage techniques. The database 122 may be resident in the same computing device as the application program, it may be resident in another computing device, it may be implemented as an independent system, or it may be distributed among many systems. Examples of the computing device includes, but is not limited to, a mobile phone, desktop computer, portable digital assistant (PDA), smart phone, tablet, ultra-book, netbook, laptop, multi-processor system, microprocessor-based or programmable consumer electronic system, or any other communication device that the user 120 may use.

FIG. 2 is a schematic representation of an exemplary embodiment of a system to investigate threat actors of FIG. 1 in accordance with an embodiment of the present disclosure. The processing subsystem includes the receiving module 110, the correlation module 112, the vision module 114 and the record module 118. Further, the vision module 114 includes a search module 210 and an input module 215. Furthermore, the processing subsystem includes an alert module 220.

The search module 210 is configured to render a plurality of currencies associated with an input, wherein the input is received from a user.

The input module 215 is configured to receive at least one of a plurality of wallet addresses and personally identifiable information as input from the user and subsequently represent the relationship between the plurality of wallet addresses via one of the plurality of transactions and personally identifiable information from third party breaches.

The alert module 220 is operatively coupled to the correlation engine wherein the alert module is configured to generate an alert to the user at the occurrence of a change in at least one or the personally identifiable information, threat actors and blockchain transactions.

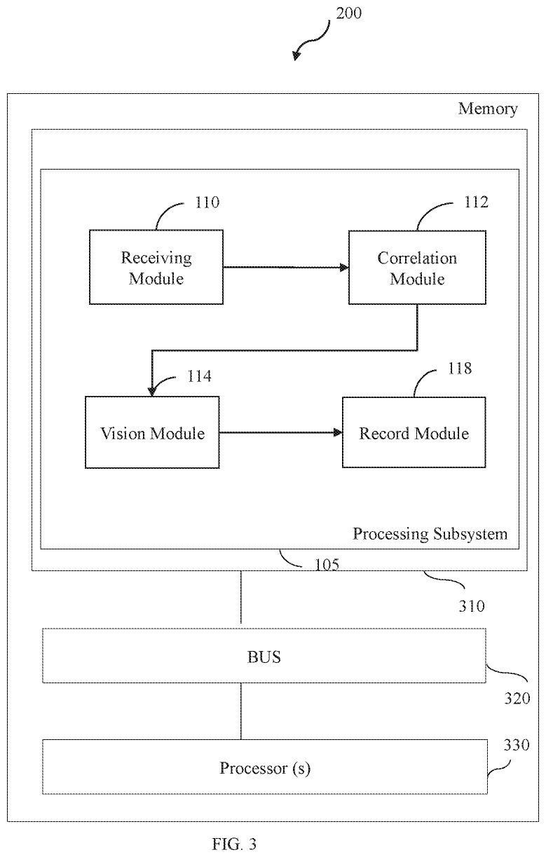

FIG. 3 is a block diagram of a computer or a server in accordance with an embodiment of the present disclosure. The server 105 includes processor(s) 330, and memory 310 operatively coupled to the bus 320. The processor(s) 330, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 310 includes several subsystems stored in the form of computer-readable medium which instructs the processor to perform the method steps illustrated in FIG. 1. The memory 310 includes several subsystems stored in the form of executable program which instructs the processor 330 to perform the method steps illustrated in FIG. 1. The memory 310 includes a processing subsystem 105 of FIG. 1. The processing subsystem 105 further has following modules: a receiving module 110, a correlation module 112, a vision module 114 and a record module 118.

The processing subsystem 105 is configured to execute on a network to control bidirectional communications among a plurality of modules. The processing subsystem includes a receiving module 110 configured to acquire a plurality of blockchain transactions, personally identifiable information from a plurality of data sources and data of one or more known threat actors with corresponding wallet addresses. The processing subsystem 105 also includes a correlation engine 112 operatively coupled to the receiving module 110 wherein the correlation engine 112 is configured to map the blockchain transactions with the personally identifiable information. Further, the processing subsystem 105 includes a vision module 114 operatively coupled to the correlation engine 112 wherein the vision module 114 is configured to display one or more graphical representations depicting the plurality of blockchain transactions and the one or more known threat actors with the corresponding walled addresses. Furthermore, the processing subsystem 105 includes a record module 118 operatively coupled to the vision module 114 wherein the record module 118 is configured to deliver a plurality of user stories and check for a change in at least one of the personally identifiable information and blockchain transactions thereby identifying a potential threat actor.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

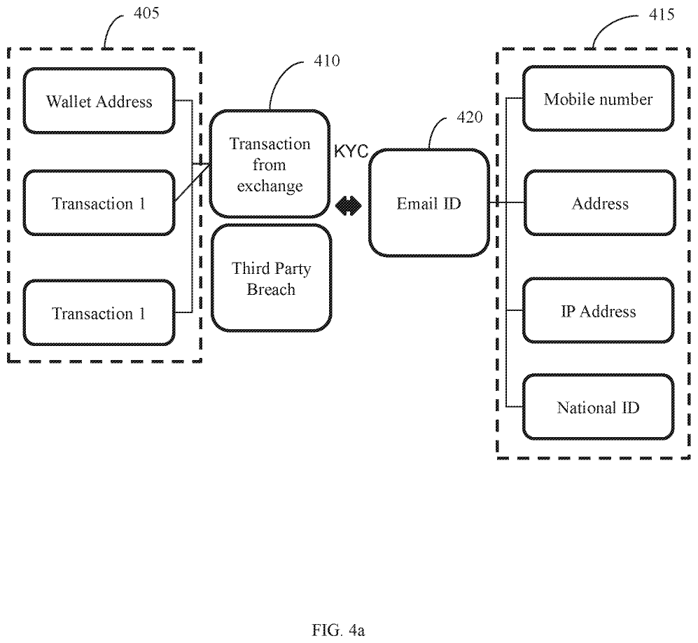

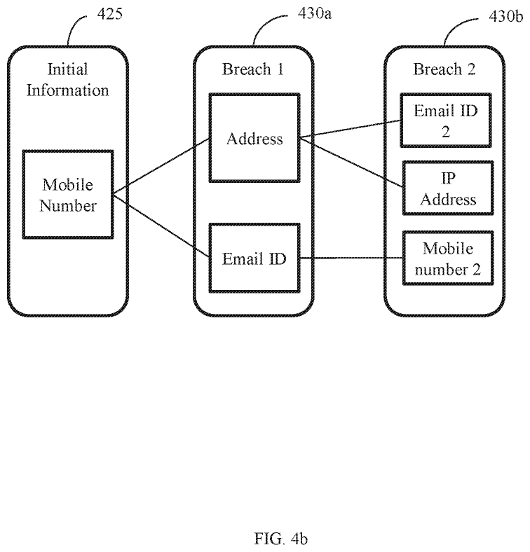

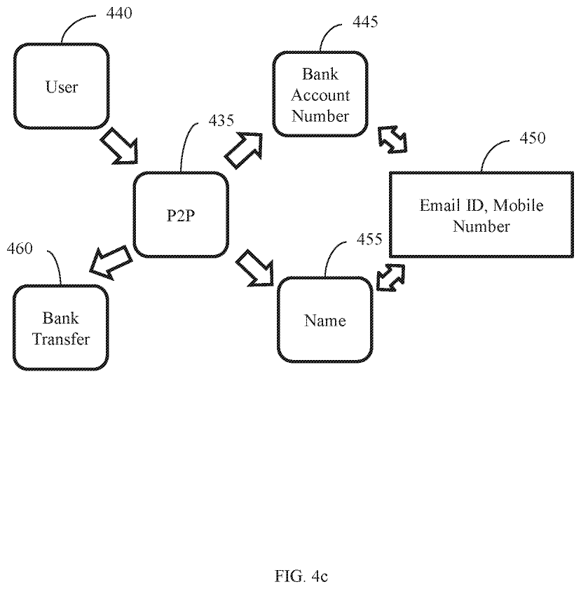

FIG. 4a, FIG. 4b and FIG. 4c are schematic representations of use case scenarios of a system to investigate threat actors of FIG. 1 in accordance with an embodiment of the present disclosure. It must be noted that FIG. 4a-FIG. 4c represents the best mode to practice the present disclosure.

FIG. 4a illustrates the correlation of matching data points of a user (Person of Interest (POI)) from multiple sources. The data 405 from transactions on cryptocurrency can be used from the respective currencies of available blockchain. The transactions 410 will have information such as walled ID, transaction hash, sender's wallet address and receiver's wallet address. The trail from these transactions can be traced to currency exchanges where the cryptocurrencies are exchanged for currency. The exchanges operate under Know Your Customer (KYC) norms and provides information to the Law Enforcement Agencises upon a user request. In one embodiment, the user can request for customer information for flagged transcactions and receive the personally identificable information. Using the PII 420 from the user requests, the data points related to this PII from third-party breaches can be used to identify the POI historical patterns 415 like addresses, mobile numbers, IP addresses and the like.

FIG. 4b illustrates a scenario when PII 425 or a machine is compromised by a threat actor or a POI, for instance mobile number. In such a scenario, all associated data points from Third Party breaches 430a and 430b that are associated to the said mobile number is used to triangulate or find patterns in the threat actor's usage and activities.

FIG. 4c illustrates a scenario where P2P exchanges 435 allows the user 440 to exchange cryptocurrencies for currency transfer to a bank account through which the currency transfer are done. Additionally, using the account number 445, email id 450 or name 455 and the transaction details 460, the related data points such as addresses or mobile numbers are identified for the POI.

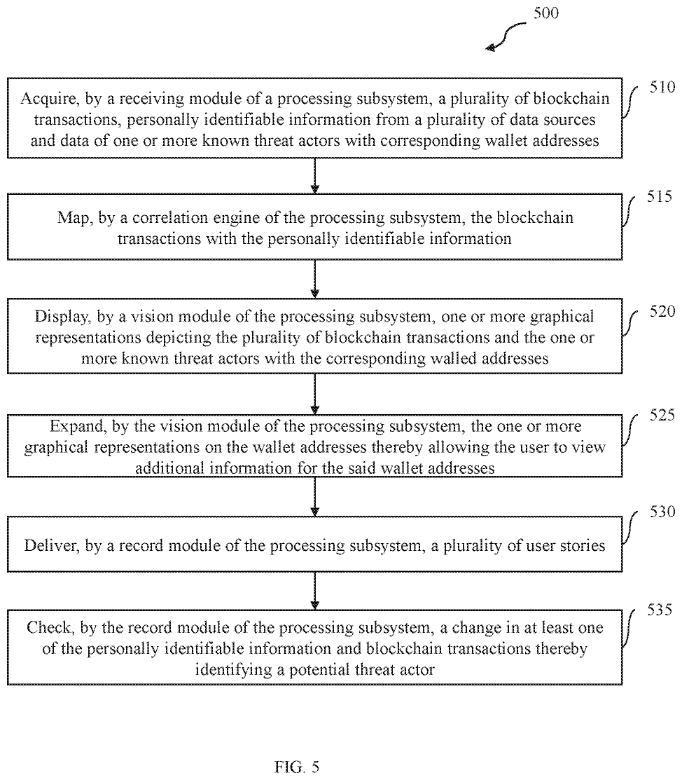

FIG. 5 illustrates a flow chart representing the steps involved in a method for investigating threat actors in accordance with an embodiment of the present disclosure. The method begins at step 510 with the pre-requistes or requirements to perform the method disclosed herein.

At step 510, a plurality of blockchain transactions, personally identifiable information from a plurality of data sources and data of one or more known threat actors with corresponding wallet addresses is acquired by a receiving module of a processing subsystem.

The blockchain transactions are fed from a Blockchair API. Typically, the Blockchair provides ‘daily dumps’ (or in other words, latest statistics) of transaction data (number of cryptocurrencies) in a structured format. Using the ‘daily dumps’, historical data is used for analysis.

Further, the personally identifiable information (PII) is fetched from third-party breaches in the form of structured comma-separated values (CSV) with uniform headers. Examples of the uniform headers, include but is not limited to, name, email, id, mobile number, wallet address, passport number, location (co-ordinates), bank account number.

Furthermore, a CSV of known threat actors and their corresponding wallet addresses is provided to the receiving module. In one embodiment, the receiving module may obtain information from various sources, for instance, but not limited to, publicly flagged wallet address and private investigations of threat actors on dark web forums. Typically, these wallet addresses are flagged in the visualization of the transactions (explained further in step 520).

It must be noted that cryptocurrency statistics, blocks and transactions are indexed with corresponding fields. A query to blockchair ‘stats’ API is applied to retrieve the id of the latest transaction block. Similarly, a query to the blockchair ‘blocks’ API and blockchair ‘transactions’ API is applied to retrieve a list of transactions for pending blocks and to obtain the details of the transactions respectively. The latest block id is compared with the last read block id to get a list of blocks to read. Specifically, the blockchair ‘transactions’ API provides details for each transaction. In order to retrieve these details, the currency and transaction id is required. In one embodiment, blockchair ‘transactions’ API accepts multiple transaction ids in a CSV format as a string.

In one embodiment, information can be retrieved based on the latest transaction block. This block would typically holds information about recent transactions processed in the said block.

At step 515, the blockchain transactions is mapped with the personally identifiable information, by a correlation engine of the processing subsystem. The mapping is performed by developing a correlation logic to generate user stories. Exemplary user stories are described as follows:
1. User story 1: The user searches for a wallet address to get records corresponding to the wallet address. A search box allows a user to enter a blockchain address and subsequently fetch a list of cryptocurrencies associated with the said blockchain address. Upon selecting a cryptocurrency, the user will be allowed to see a transaction history in chronological descending order. In one embodiment, the user is allowed to select a transaction and retrieve its corresponding details. In such an embodiment, the transaction details should include the fields for instance, datetime of transaction, amount transaction, transaction fee and sender and recipients.
2. User story 2: The user searches for a transaction hash or id to obtain the details of the transaction and associated records. A search box is provided to the user to input a transaction hash or id and obtains a list of cryptocurrencies associated with it. The transaction details should include the fields for instance, datetime of transaction, amount transaction, transaction fee and sender and recipients.
3. User story 3: The user searches for records by entering a PII. Examples of the PII includes, but is not limited to, email id, mobile number, national id number. For instance, consider a user who inputs a mobile number. All the email IDs, addresses, wallet information associated with the said mobile number will appear in a resulting chart.
4. User story 4: The user searches for two wallet addresses to check if they are associated and subsequently gets the association path. The two wallet addresses are entered by the user. Subsequently, all the transactions associated with the given wallet addresses are verified to identify if there are any transactions in which the addresses are associated. If there are such transactions, the result of the user search would include the trail for all the associated transactions.
5. User story 5: The user selects a record from the search results. The record would be the starting point for exploration and clicks on a point to explore further. Once a user enters an input of one of wallet address or transaction hash or transaction ID. It must be noted that the user is allowed to click on a ‘+’ or double clock on a bubble to view additional information such as transactions on the same wallet. At this point, the visualization expands to show the associated information for the wallet, for instance name, email ID, mobile number and the like. In one embodiment, the user clicks on the bubbles and related information for all the bubbles gets populated.

In one embodiment, the cryptocurrencies are Bitcoin, Ethereum, Litecoin, Cardano, Ripple, Polkadot, Dogecoin, Solana, Bitcoin cash, Stellar, Monero, EOS, Kusama, Bitcoin SV, eCash, ZCash, Dash, Mixin and Groestlcoin.

Further, at least one of a plurality of wallet addresses and personally identifiable information is received as an input from the user and subsequently represent the relationship between the plurality of wallet addresses via one of the plurality of blockchain transactions and personally identifiable information from third party breaches.

At step 520, one or more graphical representations depicting the plurality of blockchain transactions and the one or more known threat actors with the corresponding walled addresses are displayed, by a vision module of the processing subsystem. The plurality of blockchain transactions along with associated PII is represented.

At step 525, the one or more graphical representations on the wallet addresses are expanded, by the vision module of the processing subsystem, thereby allowing the user to view additional information for the said wallet addresses.

At step 530, a plurality of user stories are delivered, by a record module of the processing subsystem. The user stories represent how a user interacts with the system to get the desired analysis. Specifically, the user stories represent the scale and breadth of the present invention by mapping blockchain transactions with other data and subsequently correlating the said.

At step 535, a change in at least one of the personally identifiable information and blockchain transactions is checked, by the record module of the processing subsystem, thereby identifying a potential threat actor.

The plurality of blockchain transactions are checked with the corresponding wallet address to verify the occurrence of transactions for the said wallet address and subsequently display a trail for one or more associated transactions.

The method ends at step 535.

Various embodiments of the system and method for investigating threat actors in cryptocurrency transactions provides several benefits. One such benefit is that the investigators get the ability to establish ownership of wallets and track cryptocurrency transactions between various threat actors and their associated counter parties. Another benefit is the improved threat actor profiling. Further, an additional revenue stream is generated by creating a new service SKU that is specifically used by investigators. Furthermore, a differntiator is created with easy and enriched investigative capability.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to investigate threat actors comprising:
a processing subsystem hosted on a server, wherein the processing subsystem is configured to execute on a network to control bidirectional communications among a plurality of modules comprising:
a receiving module configured to acquire a plurality of blockchain transactions, personally identifiable information from a plurality of data sources and data of one or more known threat actors with corresponding wallet addresses;
a correlation engine operatively coupled to the receiving module wherein the correlation engine is configured to map the blockchain transactions with the personally identifiable information;
a vision module operatively coupled to the correlation engine wherein the vision module is configured to display one or more graphical representations depicting the plurality of blockchain transactions and the one or more known threat actors with the corresponding walled addresses; and
a record module operatively coupled to the vision module wherein the record module is configured to:
deliver a plurality of user stories; and
check for a change in at least one of the personally identifiable information and blockchain transactions thereby identifying a potential threat actor.

2. The system of claim 1 wherein the vision module is configured to expand the one or more graphical representations on the wallet addresses thereby allowing the user to view additional information for the said wallet addresses.

3. The system of claim 1 wherein the vision module comprises an input module wherein the input module is configured to receive at least one of a plurality of wallet addresses and personally identifiable information as input from the user and subsequently represent the relationship between the plurality of wallet addresses via one of the plurality of transactions and personally identifiable information from third pary breaches.

4. The system of claim 1 wherein the vision module comprises a search module configured to render a plurality of currencies associated with an input, wherein the input is received from a user.

5. The system of claim 1 comprising:
an alert module operatively coupled to the correlation engine wherein the alert module is configured to generate an alert to the user at the occurrence of a change in at least one or the personally identifiable information, threat actors and blockchain transactions.

6. The system of claim 1 wherein the personally identifiable information is collected from a plurality of data points corresponding to a plurality of data sources.

7. The system of claim 4 wherein the data sources are cryptocurrency transactions, data breaches, stealer logs and ransomware attacks.

8. The system of claim 1 wherein the blockchain transactions are received from a blockchair application programming interface wherein the blockchair application programming interface provides periodic data and historical data of the plurality of transactions in a structured format.

9. The system of claim 6 wherein the blockchair application programming interface is configured to:
compare a block address corresponding to a latest transaction with a block address corresponding to a latest read transaction from the blockchain thereby obtaining a list of block addresses to investigate in the blockchain; and
obtain details of a list of transactions corresponding to one or more pending block addresses.

10. The system of claim 6 wherein the blockchair application programming interface provides current statistics for cryptocurrencies.

11. The system of claim 1 wherein one or more unspent transactions are identified and are periodically monitored to examine an occurrence of expenditure.

12. The system of claim 1 wherein the personally identifiable information from the third party breaches is in the form of a structured file with uniform headers wherein the uniform headers are added at the occurrence of new data.

13. The system of claim 1 wherein the one or more graphical representations display the details of plurality of blockchain transactions in in a text format.

14. A computer-implemented method to investigate threat actors comprising:
acquiring, by a receiving module of a processing subsystem, a plurality of blockchain transactions, personally identifiable information from a plurality of data sources and data of one or more known threat actors with corresponding wallet addresses;
mapping, by a correlation engine of the processing subsystem, the blockchain transactions with the personally identifiable information;
displaying, by a vision module of the processing subsystem, one or more graphical representations depicting the plurality of blockchain transactions and the one or more known threat actors with the corresponding walled addresses;
expanding, by the vision module of the processing subsystem, the one or more graphical representations on the wallet addresses thereby allowing the user to view additional information for the said wallet addresses;
delivering, by a record module of the processing subsystem, a plurality of user stories; and
checking, by the record module of the processing subsystem, a change in at least one of the personally identifiable information and blockchain transactions thereby identifying a potential threat actor.

15. The computer-implemented method of claim 14 comprising:
receiving, by an input module at least one of a plurality of wallet addresses and personally identifiable information as input from the user and subsequently represent the relationship between the plurality of wallet addresses via one of the plurality of blockchain transactions and personally identifiable information from third party breaches.

16. The computer-implemente method of claim 15 comprises checking the plurality of blockchain transactions with the corresponding wallet address to verify the occurrence of transactions for the said wallet address and subsequently display a trail for one or more associated transactions.

17. The computer-implemented method of claim 14 comprising:
rendering, by a search module of the vision module, a plurality of currencies associated with an input, wherein the input is received from a user.

18. The computer-implemented method of claim 14 comprising:
generating, an alert module of the processing subsystem, an alert to the user at the occurrence of a change in at least one or the personally identifiable information, threat actors and blockchain transactions.

19. The computer-implemented method of claim 14 comprising:
monitoring, by an alert module, the one or more transactions using the wallet addresses to identify a change in the personally identifiable information; and
generating, by the alert module, an alert to the user at the occurrence of a new transaction for at least one of the wallet addresses.

20. The computer-implemented method of claim 14 wherein the cryptocurrency transactions are analyzed in a silo in the absence of PII thereby identifying diverted funds.
